(19) United States
(12) Patent Application Publication
(10) Pub. No.: US 2016/0138338 A1
(43) Pub. Date: May 19, 2016

(54) Bi-Level Work Platform for ISO Tanks

(71) Applicant: Garlock Safety Systems Inc., Minneapolis, MN (US)

(72) Inventor: Robert James Olson, Medina, MN (US)

(21) Appl. No.: 14/943,515

(22) Filed: Nov. 17, 2015

Related U.S. Application Data
(60) Provisional application No. 62/081,824, filed on Nov. 19, 2014.

(51) Int. Cl. E06C 1/39; E06C 1/24; E06C 1/397; E06C 7/16; E06C 7/18

(52) U.S. Cl. CPC E06C 1/39; E06C 7/16; E06C 7/182; E06C 1/397; E06C 1/24

(57) ABSTRACT

A bi-level work platform includes a landing vertically spaced from and cantilever supported above a U-shaped base. A folding platform is pivotally connected to the landing by a pivotal platform and by gas struts. The folding platform is pivotable between a storage condition within the maximum extent of the landing and the pivotal platform and an operating condition extending from and generally parallel to the landing. The base is movable by rollers at the free ends of legs of the U-shaped base and by retractable casters which are pivotally mounted to the U-shaped base. Removable fall protection is provided on the folding platform including removable flaccid members and is pivotally received between the guide rails of the landing in the storage condition.

### BACKGROUND

A portable work platform, particularly, a bi-level work platform, and specifically, a bi-level work platform for ISO tanks mounted on truck trailers is shown and described.

ISO tanks mounted on special truck trailers have drain valves located at the lower back end of the tank. The drain is generally at the level of the truck trailer frame rails, but can be slightly above or below them. Thus, a need exists for providing 360 degree fall protection while workers access the drain such as for draining the ISO tank.

### SUMMARY

This need and other problems in the field of fall protection is solved by providing a portable, bi-level work platform for ISO tanks including a landing vertically spaced from and supported in a cantilever manner above a base adapted to be movably supported upon a floor. A folding platform is pivotally connected to the front portion of the landing by a pivotal platform having opposite first and second edges and by a pivotal interconnection having first and second ends, with both pivotally connected to the folding platform and the front portion of the landing. A ladder extends from the base to the rear portion of the landing.

In illustrative embodiments, the pivotal interconnection is a gas strut, such that a distance between the first and second ends is variable and biased.

In illustrative embodiments, the base is movable from transport and operating conditions by rollers rotatably mounted to free ends of a U-shaped base, and by retractable casters which are pivotally mounted to the U-shaped base.

In illustrative embodiments, first and second guide rails are connected to the landing, with a gate pivotally mounted to the rearward portions thereof. Removable fall protection in the form of flaccid members extending between first and second posts and an end panel is connected to the folding platform, and is pivotally received between the first and second guide rails of the landing.

Illustrative embodiments will become clearer in light of the following detailed description in connection with the drawings.

### DESCRIPTION OF THE DRAWINGS

The illustrative embodiments may best be described by reference to the accompanying drawings where:

FIG. 1 shows a perspective view of a work platform for ISO tanks.

FIG. 2 shows a perspective view of the work platform of FIG. 1 in use.

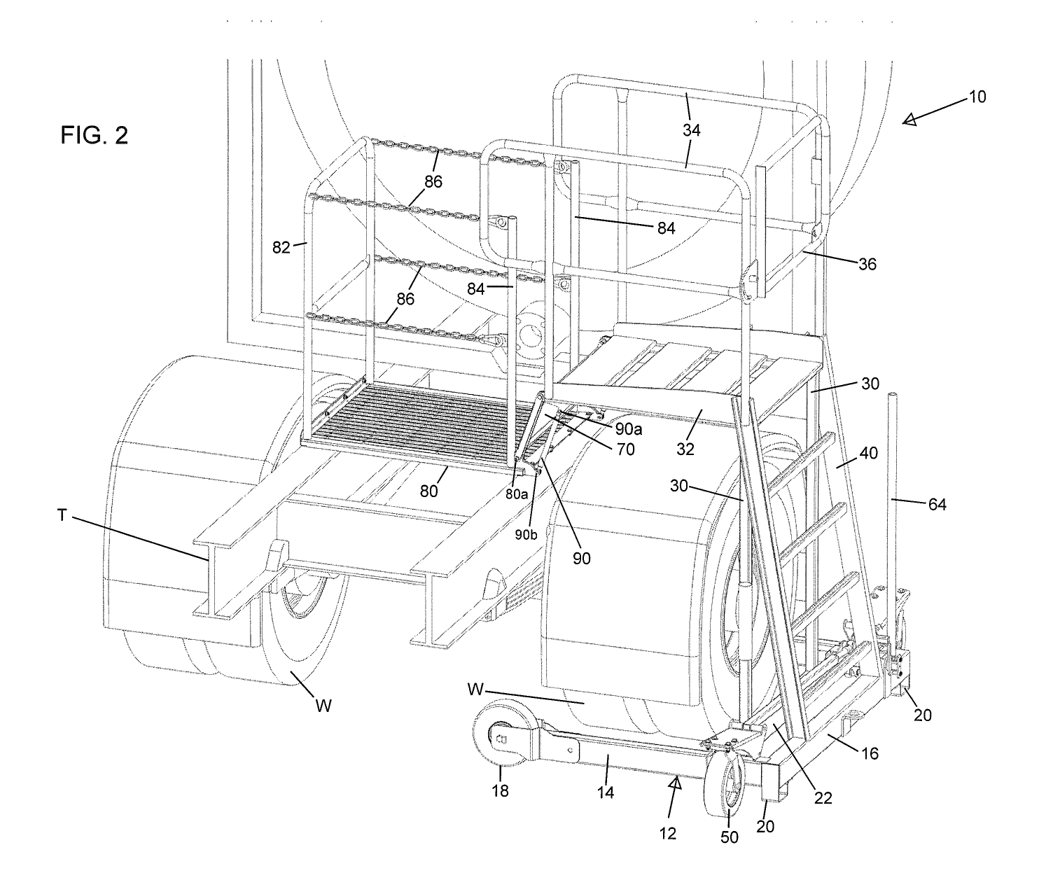

FIG. 3 shows a partial end view of the work platform of FIG. 1 in a first position.

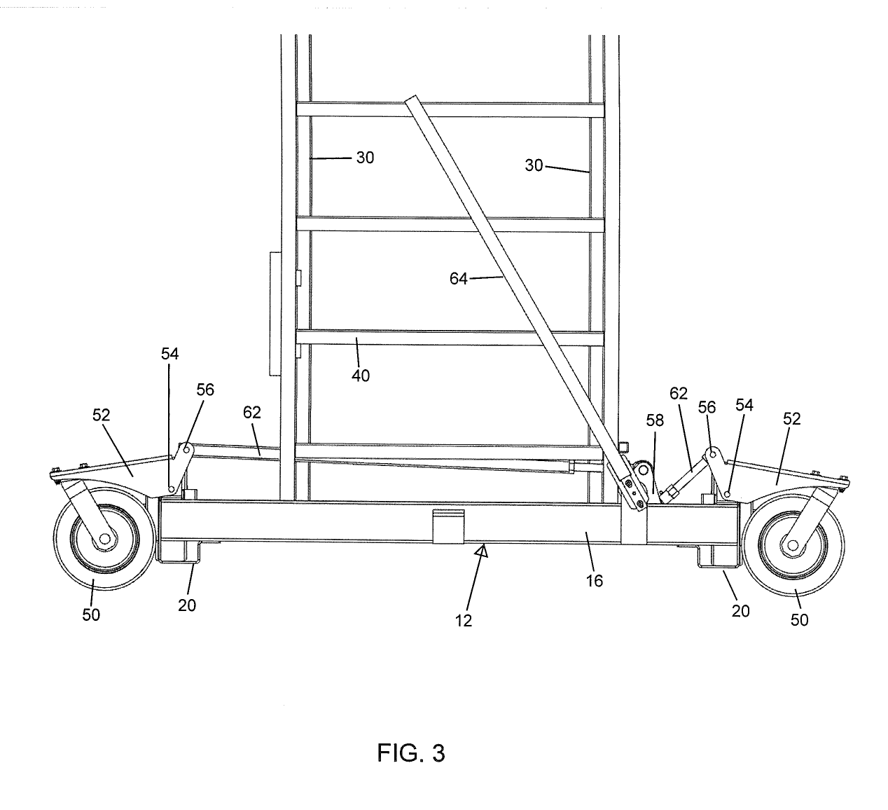

FIG. 4 shows a partial end view of the work platform of FIG. 1 in a second position.

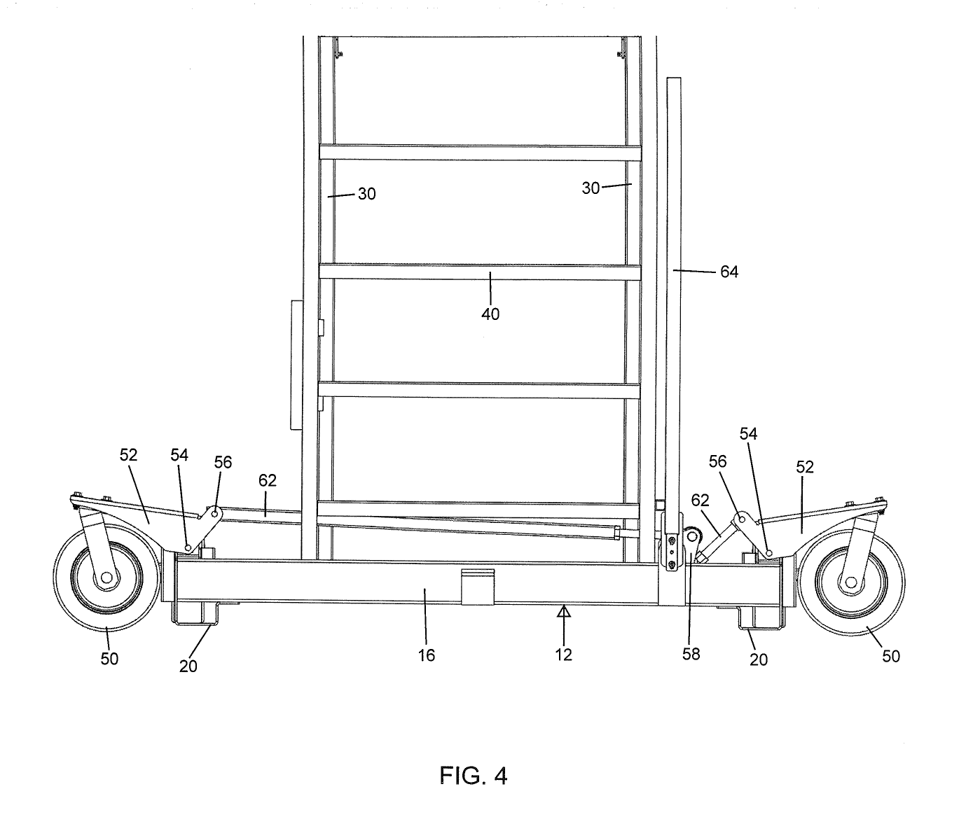

All figures are drawn for ease of explanation of the basic teachings only; the extensions of the figures with respect to number, position, relationship, and dimensions of the parts to form the illustrative embodiments will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in the various figures of the drawings, the same numerals designate the same or similar parts. Furthermore, when the terms “top”, “bottom”, “first”, “second”, “forward”, “rearward”, “reverse”, “front”, “back”, “height”, “width”, “length”, “end”, “side”, “horizontal”, “vertical”, and similar terms are used herein, it should be understood that these terms have reference only to the structure shown in the drawings as it would appear to a person viewing the drawings and are utilized only to facilitate describing the illustrative embodiments.

### DESCRIPTION OF THE ILLUSTRATIVE EMBODIMENTS

A work platform for International Organization for Standardization (ISO) tanks mounted on truck trailers is shown and generally designated 10. Generally, platform 10 includes a U-shaped base 12 moveably supported upon a floor and including first and second legs 14 interconnected by a head piece 16 extending perpendicularly therebetween. Legs 14 are spaced sufficient to straddle the tires W of a truck trailer T. Rollers or wheels 18 are rotatably mounted to the free ends of legs 14 about an axis parallel to but spaced from head piece 16. Standoffs 20 are provided on head piece 16 having a height so that when wheels 18 and standoffs 20 are located on the floor, legs 14 are generally horizontal and parallel to the floor. Base 12 further includes an interconnection piece 22 extending between legs 14 generally parallel to but spaced from head piece 16 and intermediate the free ends of legs 14 and head piece 16.

First and second uprights 30 extend perpendicularly from interconnection piece 22 and are located intermediate and spaced from legs 14. A landing 32 of a rectangular shape is secured to uprights 30 in a cantilevered manner vertically spaced above and extending parallel to legs 14. Suitable first and second guide rails 34 extend from landing 32 generally parallel to and spaced above legs 14. In the form shown, uprights 30 extending above landing 32 form the rearward portion of guide rails 34. A gate 36 is pivotable mounted to one upright 30 and can be removably locked to the other upright 30.

A ladder 40 has its lower ends attached to head piece 16 and its upper end attached to uprights 30 and/or the rear portion of landing 32. Due to the spacing of head and interconnection pieces 16 and 22, ladder 40 extends at an obtuse angle from base 12 and acts as a brace for maintaining uprights 30 in a vertical condition relative to base 12.

First and second retractable casters 50 are attached to base 12 adjacent to head piece 16, with casters 50 including wheels which are rotatably mounted about axes in a plane parallel to and spaced from the floor. In the form shown, first and second brackets 52 are pivotally mounted to legs 14 intermediate head and interconnection pieces 16 and 22. Particularly, each bracket 52 has a triangular shape, with one caster 50 mounted adjacent a first corner, a hinge 54 pivotally mounting bracket 52 to one leg 14 about a pivot axis parallel to the one leg 14 at a second corner, and a pivot connection 56 at a third corner. Casters 50 allow the wheels to rotate about axes relative to brackets 52 which are generally perpendicular to the axes of the wheels. A crank 58 is rotatably mounted about a crank axis between head and interconnection pieces 16 and 22 by a shaft extending parallel to, spaced from and intermediate the pivot axes of hinges 54. First and second linkages 62 have first ends pivotally connected to pivot connectors 56 of first and second brackets 52 and have second ends pivotally connected to crank 58 at circumferentially spaced axes parallel to and spaced from the axes of hinges 54. A handle 64 extends perpendicularly from an end of the shaft of crank 58, with ladder 40 located intermediate handle 64 and crank 58. Handle 64 is pivotal between a first position to pivot brackets 52 so that casters 50 extend downwardly beyond legs 14 and pieces 16 and 22, and a second position to pivot brackets 52 so that casters 50 are located above the lower extent of standoffs 20. In the form shown, handle 64 in the first position extends to a position intermediate uprights 30 and in front of ladder 40 and in the second position is generally parallel to uprights 30 and to the side of ladder 40.

Work platform 10 further includes a pivotal platform 70 having a first edge pivotally mounted to a front portion of landing 32 about a first axis extending parallel to and spaced from head and interconnection pieces 16 and 22 and the axes of wheels 18 and a second edge spaced from and parallel to the first edge. Work platform 10 further includes a folding platform 80 pivotally mounted to the second edge of pivotal platform 70 about a pivot axis 80a extending parallel to and spaced from the first axis. A pivotal interconnection shown as first and second gas struts 90 is pivotally connected between landing 32 and folding platform 80. Specifically, gas struts 90 have first, upper ends pivotally connected at an axis 90a located intermediate the first edge of pivotal platform 70 and uprights 30 and below landing 32 and extending parallel to and spaced from the first axis and pivot axis 80a. Gas struts 90 have second, lower ends pivotally connected at an axis 90b located generally parallel to and spaced outwardly of the rear edge of folding platform 80 and extending parallel to and spaced from the first axis and axes 80a and 90a. The distance between the upper and lower ends of gas struts 92 are variable and are biased due to the compression of gas therein. The pivot axes of hinges 54 are generally perpendicular to the first pivot axis and axes 80a, 90a and 90b. The first axis and axis 90a are located intermediate the forward and rearward portions of guide rails 34. The pivot axis 80a between folding platform 80 and pivotal platform 70 is located intermediate and spaced from folding platform 80 and axis 90b and landing 32. Legs 14 extend parallel to landing 32 towards the first axis and axes 80a, 90a and 90b.

Folding platform 80 includes removable fall protection shown as including an A-shaped end panel 82 at the front edge of folding platform 80 parallel to and spaced from axes 80a and 90b, first and second posts 84 adjacent the rear edge of folding platform 80 and extending perpendicularly to folding platform 80 and axes 80a and 90b, and spaced, parallel flaccid members shown as chains 86 secured to end 82 and removably connected to posts 84 extending parallel to folding platform 80 and perpendicular to axes 80a and 90b. The width between posts 84 and of end panel 82 is less than the width between guide rails 34.

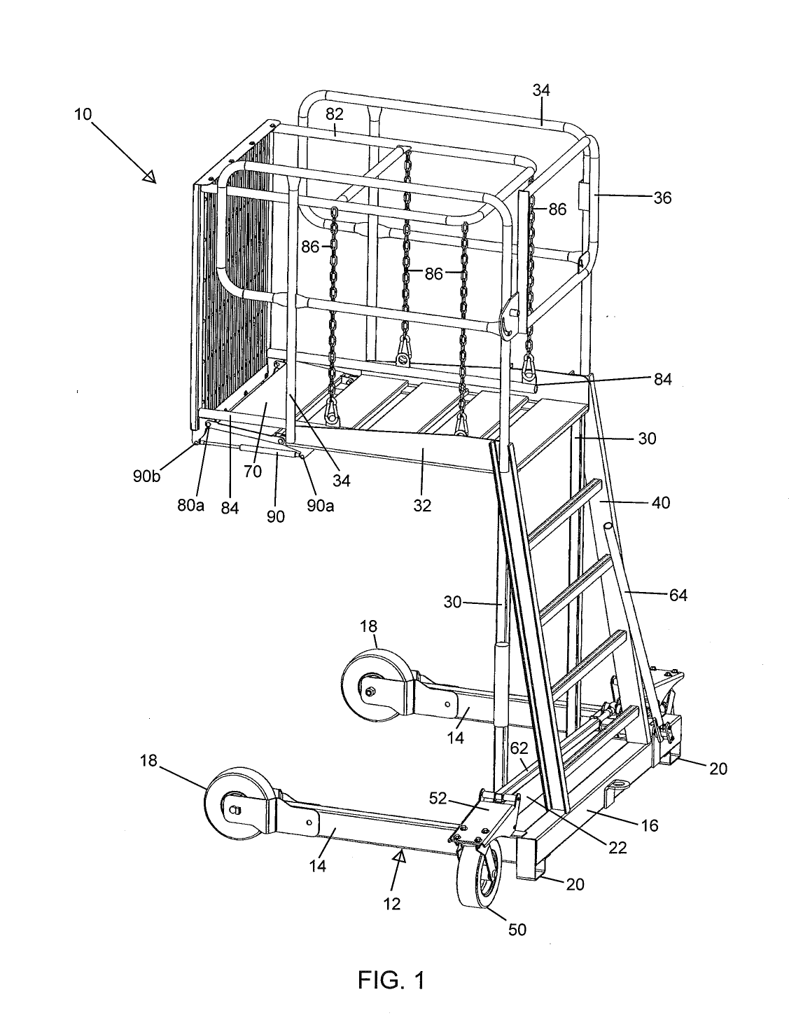

Work platform 10 generally has a transport and storage condition shown in FIG. 1 with handle 64 in the first position such that casters 50 extend downwardly beyond legs 14 and pieces 16 and 22 so that work platform 10 can be moved on the floor utilizing wheels 18 and casters 50. In the first position, handle 64 is located in front of ladder 40 to discourage users from attempting to scale ladder 40. Furthermore, in the transport and storage condition, pivotal platform 70 extends generally contiguously and parallel to landing 32, and folding platform 80 extends at a non-parallel angle shown as generally perpendicular to pivotal platform 70 with posts 84 extending generally parallel to and abutting pivotal platform 70 and landing 32. Gas struts 90 in the transport and storage condition are extended. In the transport and storage condition, work platform 10 can be moved upon the floor to truck trailer T such that legs 14 are located on opposite sides of tires W and with interconnection piece 22 parallel to and abutting tires W.

After positioning relative to truck trailer T, work platform 10 can be transformed to its operating condition. Specifically, handle 64 can be pivoted to its second position such that casters 50 are retracted and standoffs 20 abut the floor to prevent movement of base 12 relative to the floor. In the second position, handle 64 does not obstruct ladder 40, such that the user can scale ladder 40, open gate 36, and can move onto landing 32. The user can then pivot folding platform 80 relative to landing 32. It should be appreciated that pivoting folding platform 80 causes pivotal platform 70 to pivot relative to landing 32 and folding platform 80 to pivot relative to pivotal platform 70. Due to gas struts 90, folding platform 80 will pivot to a horizontal position parallel to landing 32 with the vertical spacing of folding platform 80 being dependent upon if abutment occurs with an obstruction such as the supports of truck trailer T. Pivotal platform 70 will extend at a non-parallel angle between landing 32 and folding platform 80 depending upon the vertical spacing of folding platform 80 from landing 32. Thus, it should be appreciated that landing 32 and folding platform 80 form a bi-level platform with folding platform 80 located at a horizontal position to match the service area. Furthermore, folding platform 80 is self-leveling due to gas struts 90 to always be in a horizontal position when unfolded and supported such as by abutting with truck trailer T. Once folding platform 80 is matched to the service area and the user has moved unto folding platform 80, chains 86 can be removed from connection to the corresponding post 84 as desired for ease of access to the service area.

After servicing has been completed, the reverse procedure can be performed to ready work platform 10 for storage or for servicing another service area. To discourage anyone from walking unto folding platform 80 when work platform 10 is in storage or between service areas, folding platform 80 slants downward if unfolded but not supported.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Work platform comprising, in combination: a base adapted to be moveably supported upon a floor; a landing vertically spaced from the base and supported in a cantilever manner above the base, with the landing having a front portion and a rear portion; a ladder extending from the base to the rear portion of the landing; a pivotal platform having a first edge and a second edge opposite to the first edge, with the first edge pivotally mounted to the front portion of the landing about a first axis; a folding platform having a free edge and a rear edge opposite to the free edge, with the folding platform pivotally connected to the second edge of the pivotal platform about a second axis; and a pivotal interconnection having a first end and a second end opposite to the first end, with the first end pivotally connected to the landing about a third axis parallel to the first and second axes, and with the second end pivotally connected to the folding platform about a fourth axis parallel to the first, second, and third axis, with the folding platform moveable from a storage condition and an operating condition extending from and generally parallel to the landing, with the folding platform extending at a non-parallel angle to the landing in the storage condition.

2. The work platform of claim 1 wherein a distance between the first and second ends of the pivotal interconnection is variable.

3. The work platform of claim 2 wherein the distance between the first and second ends is biased.

4. The work platform of claim 3 wherein the pivotal interconnection is a gas strut.

5. The work platform of claim 4 wherein the base is generally U-shaped and includes first and second legs interconnected by a head piece extending therebetween, with the head piece extending parallel to the first, second, third and fourth axes, with the first and second legs extending parallel to the landing and from the head piece towards the first, second, third and fourth axes.

6. The work platform of claim 5 further comprising, in combination: an interconnection piece extending between the first and second legs spaced from and parallel to the heat piece; and first and second uprights extending between and interconnected to the landing and the interconnection piece, with the ladder extending from the head piece at an obtuse angle to the base.

7. The work platform of claim 6 further comprising, in combination: first and second rollers rotatably mounted to free ends of the first and second legs about axes parallel to and spaced from the first, second, third and fourth axes; and first and second casters mounted to the base and having wheels which are rotatably mounted about axes in a plane parallel to the floor.

8. The work platform of claim 7 further comprising, in combination: first and second standoffs fixed relative to the base, with the first and second casters movable between a first position with the wheels of the first and second casters extending below the base and a second position with the wheels of the first and second casters located above the first and second standoffs.

9. The work platform of claim 8 wherein the first and second casters are pivotally mounted by hinges about pivot axes extending perpendicular to the first, second, third and fourth axes, and wherein the work platform further comprises, in combination: a crank rotatably mounted by a shaft to the base about a crank axis spaced intermediate and parallel to the pivot axes; a first linkage having a first end pivotally connected to the hinge of the first caster and a second end pivotally connected to the crank; a second linkage having a first end pivotally connected to the hinge of the second caster and a second end pivotally connected to the crank; and a handle connected to the shaft.

10. The work platform of claim 9 further comprising, in combination: first and second guide rails connected to the landing and having a forward portion and a rearward portion, with the first and second uprights forming the rearward portion, with the first and third axes located intermediate the forward and rearward portions.

11. The work platform of claim 10 further comprising, in combination: a gate pivotally mounted to the first upright and removably locked to the second upright.

12. The work platform of claim 11 further comprising, in combination: an end panel connected to the folding platform opposite to the second and fourth axes; first and second posts extending from opposite sides of the folding platform; and flaccid members removably extending between the first and second posts and the end panel, with a distance between the first and second posts being less than between the first and second guide rails.

13. The work platform of claim 12 wherein the third axis is located intermediate the first axis and the base; and wherein the fourth axis is located intermediate the second axis and the base.

14. The work platform of claim 1 wherein the base is generally U-shaped and includes first and second legs interconnected by a head piece extending therebetween, with the head piece extending parallel to the first, second, third and fourth axes, with the first and second legs extending parallel to the landing and from the head piece towards the first, second, third and fourth axes.

15. The work platform of claim 14 further comprising, in combination: first and second rollers rotatably mounted to free ends of the first and second legs about axes parallel to and spaced from the first, second, third and fourth axes; and first and second casters mounted to the base and having wheels which are rotatably mounted about axes in a plane parallel to the floor.

16. The work platform of claim 15 further comprising, in combination: first and second standoffs fixed relative to the base, with the first and second casters movable between a first position with the wheels of the first and second casters extending below the base and a second position with the wheels of the first and second casters located above the first and second standoffs.

17. The work platform of claim 16 wherein the first and second casters are pivotally mounted by hinges about pivot axes extending perpendicular to the first, second, third and fourth axes, and wherein the work platform further comprises, in combination: a crank rotatably mounted by a shaft to the base about a crank axis spaced intermediate and parallel to the pivot axes; a first linkage having a first end pivotally connected to the hinge of the first caster and a second end pivotally connected to the crank; a second linkage having a first end pivotally connected to the hinge of the second caster and a second end pivotally connected to the crank; and a handle connected to the shaft.

18. The work platform of claim 1 further comprising, in combination: first and second guide rails connected to the landing and having a forward portion and a rearward portion, with the first and third axes located intermediate the forward and rearward portions.

19. The work platform of claim 18 further comprising, in combination: a gate pivotally mounted to the first guide rail and removably locked to the second guide rail.

20. The work platform of claim 19 further comprising, in combination: an end panel connected to the folding platform opposite to the second and fourth axes; first and second posts extending from opposite sides of the folding platform; and flaccid members removably extending between the first and second posts and the end panel, with a distance between the first and second posts being less than between the first and second guide rails.
